(19) United States
(12) Patent Application Publication
(10) Pub. No.: US 2014/0330684 A1
(43) Pub. Date: Nov. 6, 2014

(54) ELECTRONIC DEVICE, INFORMATION PROCESSING METHOD AND PROGRAM

(71) Applicant: NIKON CORPORATION, Tokyo (JP)

(72) Inventors: Kengo Mizui, Zushi-shi (JP); Hisashi Tai, Kawasaki-shi (JP); Takafumi Toyoda, Chigasaki-shi (JP); Mayuko Ito, Kawasaki-shi (JP); Yuki Kinouchi, Yokohama-shi (JP); Masakazu Sekiguchi, Kawasaki-shi (JP)

(73) Assignee: NIKON CORPORATION, Tokyo (JP)

(21) Appl. No.: 14/354,738

(22) PCT Filed: Oct. 11, 2012
(86) PCT No.: PCT/JP2012/006534

§ 371 Date: Apr. 28, 2014

(30) Foreign Application Priority Data
Dec. 7, 2011 (JP) 2011-267649
Dec. 7, 2011 (JP) 2011-267663
Dec. 7, 2011 (JP) 2011-267664

(51) Int. Cl. G06Q 30/06; G06F 17/30

(52) U.S. Cl. CPC G06Q 30/0643; G06F 17/30247
USPC 705/27.2

(57) ABSTRACT

An electronic device that is convenient to use is provided. The electronic device provided includes an operating unit that receives an operation of a user; an image capturing unit that is able to capture an image of an appearance of the user; an information providing unit that provides information to the user based on the image captured by the image capturing unit, wherein the image capturing unit captures an image of the user when the user is operating the operating unit.

The contents of the following Japanese and PCT patent applications are incorporated herein by reference:

No. JP2011-267649 filed on Dec. 7, 2011,

No. JP2011-267663 filed on Dec. 7, 2011,

No. JP2011-267664 filed on Dec. 7, 2011, and

No. PCT/JP2012/006534 filed on Oct. 11, 2012.

### 1. TECHNICAL FIELD

The present invention relates to an electronic device, an information processing method, and a program.

### 2. RELATED ART

Conventionally, there has been a system proposed to classify types of clothing worn by a person by distinguishing colors, cloth, and the like or distinguishing the shapes of collars, sleeves, and the like after capturing an image of the person (e.g., Patent Document No. 1). Also, a system to introduce shops and the like to a user based on a position of the user detected by using a mobile terminal has been proposed (e.g., Patent Document No. 2).
Patent Document No. 1: Japanese Patent Application Publication No. 2010-262425
Patent Document No. 2: Japanese Patent Application Publication No. 2010-9315

### SUMMARY

However, the conventional system for classifying types of clothing requires preparation of equipment for capturing an image of and classifying clothing of a user, and there needs to be someone who takes a picture; thus, the system has been inconvenient to use. The conventional system of introducing shops takes only positional information of a user into consideration, and thus has been inconvenient to use.

According to a first aspect of the present invention, an electronic device includes: an image capturing unit that is able to capture an image of an appearance of a user; and an information providing unit that provides information to the user based on the image captured by the image capturing unit.

According to a second aspect of the present invention an information processing method includes: capturing an image of an appearance of a user with an image capturing unit that is able to capture the image of the appearance of the user; and providing information to the user based on the image captured by the image capturing unit.

According to a third aspect of the present invention, a program allows a computer to execute: procedure for capturing an image of an appearance of a user with an image capturing unit that is able to capture the image of the appearance of the user; and procedure for providing information to the user based on the image captured by the image capturing unit.

According to a fourth aspect of the present invention, an electronic device includes: a display unit that displays; an image capturing unit that captures an image of a user when the display unit is not displaying; and a detecting unit that detects a state of the user when the display unit is not displaying.

According to a fifth aspect of the present invention, an information processing method includes: displaying information on a display unit; capturing an image of a user when the display unit is not displaying the information; and detecting a state of the user when the display unit is not displaying.

According to a sixth aspect of the present invention, a program allows a computer to execute: procedure for displaying information on a display unit; procedure for capturing an image of a user when the display unit is not displaying the information; and procedure for detecting a state of the user when the display unit is not displaying.

According to a seventh aspect of the present invention, an electronic device includes: an image capturing unit that is able to capture an image of a user; and a first detecting unit that detects information about an appearance of the user when the image captured by the image capturing unit includes an image of the appearance of the user.

According to an eighth aspect of the present invention, an information processing method includes: capturing an image of a user with an image capturing unit that is able to capture an image of the user; and detecting information about an appearance of the user when the image captured by the image capturing unit includes an image of the appearance of the user.

According to a ninth aspect of the present invention, a program allows a computer to execute: procedure for capturing an image of a user with an image capturing unit that is able to capture an image of the user; and procedure for detecting information about an appearance of the user when the image captured by the image capturing unit includes an image of the appearance of the user.

The summary clause does not necessarily describe all necessary features of the embodiments of the present invention. The present invention may also be a sub-combination of the features described above.

### BRIEF DESCRIPTION OF THE DRAWINGS

FIG. 1 shows the configuration of the external appearance of a mobile terminal 10 according to an embodiment.

FIG. 2 shows the functions and configuration of the mobile terminal 10 according to the present embodiment.

FIG. 3 shows a control flow of the mobile terminal 10 according to the present embodiment.

FIG. 4 shows a control flow that follows the control flow of FIG. 3.

FIG. 5 shows the configuration of the external appearance of the mobile terminal 10 according to a variant of the present embodiment.

FIG. 6 shows the functions and configuration of the mobile terminal 10 according to a variant.

FIG. 7 shows an exemplary table in which image data and a log of clothing owned by a user are described.

FIG. 8 shows a control flow of the mobile terminal 10 according to the variant.

### DESCRIPTION OF EXEMPLARY EMBODIMENTS

Hereinafter, (some) embodiment(s) of the present invention will be described. The embodiment(s) do(es) not limit the invention according to the claims, and all the combinations of the features described in the embodiment(s) are not necessarily essential to means provided by aspects of the invention.

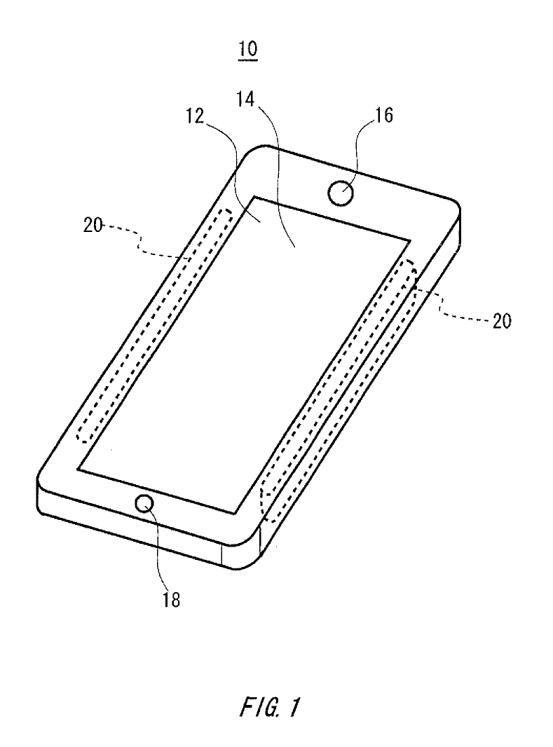

FIG. 1 shows the configuration of the external appearance of a mobile terminal 10 according to an embodiment. The mobile terminal 10 is an information device that a user carries for use. The mobile terminal 10 has a telephone function, a communication function for connection with the Internet, and the like, a data processing function for executing a program, and the like. In one example, the mobile terminal 10 has a laminar shape with a rectangle principal surface, and has a size that allows gripping with a palm of one hand.

The mobile terminal 10 includes a display 12, a touch panel 14, an built-in camera 16, a microphone 18, and a biosensor 20. The display 12 is provided on the principal surface side of a body of the mobile terminal 10. The display 12 for example has a size that occupies the most region (e.g., 90%) of the principal surface. The display 12 displays images, various types of information, and images for input operations such as buttons. In one example, the display 12 is a device in which a liquid crystal display element is used.

The touch panel 14 receives inputs of information in response to a touch by a user. The touch panel 14 is provided and incorporated on or in the display 12. Accordingly, when a user touches the surface of the display 12, the touch panel 14 receives inputs of various types of information.

The built-in camera 16 has an image capturing lens and an image capturing element, and captures images of subjects. In one example, the image capturing element is a CCD or a CMOS device. Also, in one example, the image capturing element includes the Bayer arrangement of color filters of the three primary colors, RGB, and outputs color signals corresponding to the respective colors.

The built-in camera 16 is provided on the surface of the body of the mobile terminal 10 where the display 12 is provided (i.e. the principal surface). Accordingly, the built-in camera 16 can capture an image of a face and clothing of a user who is operating the touch panel 14 of the mobile terminal 10. Also, the built-in camera 16, when having a wide-angle lens as the image capturing lens, can capture an image of, in addition to the operating user, faces and clothing of other users who are around the user (e.g., people next to the user).

Also, in addition to the built-in camera 16, the mobile terminal 10 may further include another camera on a side opposite to the principal surface. Thereby, the mobile terminal 10 can capture an image of a subject who is positioned opposite to the user.

The microphone 18 receives sound of the ambient environment of the mobile terminal 10. In one example, the microphone 18 is provided at a lower part of the principal surface of the body of the mobile terminal 10. Thereby, the microphone 18 is arranged at a position where it faces the mouth of a user, which makes it easier for the microphone 18 to receive voice of the user.

The biosensor 20 acquires information about the state of a user who is holding the mobile terminal 10. In one example, the biosensor 20 acquires information about the body temperature, blood pressure, pulse, amount of perspiration, and the like of the user. Also, in one example, the biosensor 20 acquires information about the gripping force exerted on the biosensor 20 by the user (e.g., grip).

In one example, as disclosed in Japanese Patent Application Publication No. 2005-270543, the biosensor 20 detects a pulse by irradiating light to the user with a light-emitting diode, and receiving the light having been reflected on the user. Also, in one example, the biosensor 20 acquires information detected by a watch-type biosensor as disclosed in Japanese Patent Application Publication No. 2005-270543.

Also, the biosensor 20 may include pressure sensors provided at two portions on longer sides of the body of the mobile terminal 10. The pressure sensors arranged in this manner can detect that the user is holding the mobile terminal 10, and the gripping force exerted on the mobile terminal 10.

Also, the biosensor 20 may start acquisition of biometric information after detecting, with the pressure sensors, that the user is holding the mobile terminal 10. Also, the mobile terminal 10, when it is turned on, may turn on other functions after detecting, with the pressure sensors, that the user is holding the mobile terminal 10.

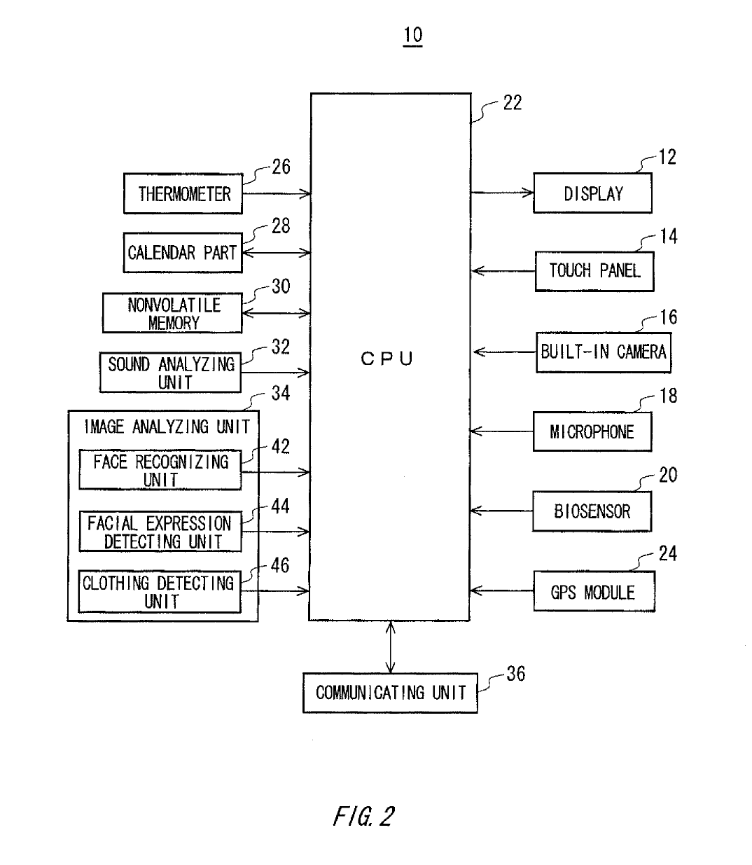

FIG. 2 shows the functions and configuration of the mobile terminal 10 according to the present embodiment. The mobile terminal 10 includes, in addition to the configuration shown in FIG. 1, a CPU (Central Processing Unit) 22, a GPS (Global Positioning System) module 24, a thermometer 26, a calendar part 28, a nonvolatile memory 30, a sound analyzing unit 32, an image analyzing unit 34, and a communicating unit 36.

The CPU 22 controls the entire operations of the mobile terminal 10. In the present embodiment, the CPU 22 performs control to provide information to the user in accordance with the clothing of the user, the location of the user, the language that the user and a person with the user speak, and the like.

The GPS module 24 detects the position of the mobile terminal 10 (e.g., latitude and longitude). The CPU 22 acquires a history of positions of the user detected by the GPS module 24, and stores the history in the nonvolatile memory 30. Thereby, the CPU 22 can detect a geographical range of activity of the user. For example, based on the positions detected by the GPS module 24, the CPU 22 registers the geographical range of activity of the user from 9 a.m. to 6 p.m. on weekdays as a business geographical range of activity (business area), and the geographical range of activity during the time zone outside the business operating hours from 9 a.m. to 6 p.m. on weekdays as a private geographical range of activity.

The thermometer 26 detects the temperature of the ambient environment of the mobile terminal 10. The thermometer 26 may share the function of detecting the user's body temperature with the biosensor 20.

The calendar part 28 acquires time information such as year, month, day, and time, and outputs the time information to the CPU 22. Furthermore, the calendar part 28 has a time keeping function.

The nonvolatile memory 30 is a semiconductor memory such as a flash memory. The nonvolatile memory 30 stores therein a program executed by the CPU 22 to control the mobile terminal 10, various parameters for controlling the mobile terminal 10, and the like. Furthermore, the nonvolatile memory 30 stores therein a schedule of the user, various types of data detected by various sensors, facial data registered by the user, facial expression data, data about clothing, and the like.

Among them, the facial expression data includes data that represents a smiling face, a crying face, an angry face, a surprised face, a facial expression with wrinkles between eyebrows, and the like. Also, the clothing data includes image data for identifying each of clothing (suit, jacket, Japanese-style clothing, tie, pocket handkerchief, coat, and the like). Also, the clothing data may be image data for identifying formal clothing (e.g., suit, jacket, Japanese-style clothing, tie, pocket handkerchief, and coat) and casual clothing (e.g., polo shirt, tee shirt, and down jacket). Also, characteristic shapes of the clothing (e.g., shape of a collar portion) may be stored in the nonvolatile memory 30.

Also, the nonvolatile memory 30 may store therein examples of verbal expressions such as honorific expressions and greetings. In the present embodiment, the CPU 22 reads out for example, in a situation where honorific expressions are required to use, honorific expressions stored in the nonvolatile memory 30, and displays them on the display 12. Also, the CPU 22 reads out, in a situation at a funeral hall and the like, condolences stored in the nonvolatile memory 30, and displays them on the display 12.

The sound analyzing unit 32 analyzes characteristics of sound taken in from the microphone 18. In one example, the sound analyzing unit 32 has a sound recognition dictionary, converts identified sound into text data, and displays the text data on the display 12. Also, when a sound recognition program is installed in the mobile terminal 10, the sound analyzing unit 32 may acquire results obtained by execution of the sound recognition program by the CPU 22 to perform sound recognition.

Also, the sound analyzing unit 32 classifies contents of language included in input sound into polite language (e.g., honorific language, polite language, humble language, and the like), ordinary language, and other casual language. In the present embodiment, the sound analyzing unit 32 classifies into polite language (honorific language, polite language and humble language) as a first category, ordinary language as a second category, and other language as a third category. When language belonging to the third category is detected, the sound analyzing unit 32 recognizes that the user is relaxed or is having conversation with an intimate person.

Also, in one example, the sound analyzing unit 32 judges classification of language according to ends of sentences in conversation. In one example, the sound analyzing unit 32 classifies into the first category when a sentence ends with “sir” as in “Good morning, sir”. Also, in one example, the sound analyzing unit 32 classifies into the second category when a phrase is one of those registered in the sound recognition dictionary like “Good morning”, which does not end with “sir” or “madam. Also, the sound analyzing unit 32 classifies into the third category when a phrase is not registered in the sound recognition dictionary like “Whassup”.

The image analyzing unit 34 analyzes an image captured by the built-in camera 16. In addition to an image captured by the built-in camera 16, the image analyzing unit 34 may analyze an image captured by a camera provided on a side opposite to the touch panel 14.

In one example, the image analyzing unit 34 has a face recognizing unit 42, a facial expression detecting unit 44, and a clothing detecting unit 46. The face recognizing unit 42 detects whether an image captured by the built-in camera 16 includes a face. Furthermore, when a face is detected in an image, the face recognizing unit 42 compares image data of a part of the detected face with image data of the face of a user stored in the nonvolatile memory 30 (e.g., pattern matching) to recognize a person whose image has been captured by the built-in camera 16. Because the built-in camera 16 is provided on a surface on the same side with the display 12 (that is, the built-in camera 16 is provided on a surface of the same side with the touch panel 14), the built-in camera 16 can capture an image of the faces of the user and a person next to the user. Accordingly, the face recognizing unit 42 can recognize the faces of the user and the person next to the user.

The facial expression detecting unit 44 compares image data of a face recognized by the face recognizing unit 42 with facial expression data stored in the nonvolatile memory 30 to detect a facial expression of people whose image has been captured by the built-in camera 16 (e.g., the user and the person next to the user). The facial expression detecting unit 44 detects a facial expression of a smiling face, a crying face, an angry face, a surprised face, a facial expression with wrinkles between eyebrows, a nervous face, a relaxed, and the like. The nonvolatile memory 30 stores a plurality of pieces of facial expression data. As one example, a method of detecting a smiling face is disclosed in U.S. Patent Application Publication No. 2008-037841. Also, as one example, a method of detecting wrinkles between eyebrows is disclosed in U.S. Patent Application Publication No. 2008-292148.

The clothing detecting unit 46 detects what type of clothing the user whose image has been captured by the built-in camera 16 wears. The clothing detecting unit 46 may perform pattern matching of image data of a portion of clothing included in a captured image and image data of clothing preregistered in the nonvolatile memory 30 to detect clothing. Furthermore, the clothing detecting unit 46 determines a types of the user's clothing. In the present embodiment, the clothing detecting unit 46 determines whether the user's clothing is formal or casual (informal).

An image that is determined to include a face by the face recognizing unit 42 includes clothing below the recognized face. Accordingly, in one example, the clothing detecting unit 46 can detect a user's clothing by performing pattern matching of an image within a predetermined range which is below a face recognized by the face recognizing unit 42, and clothing data (image data) stored in the nonvolatile memory 30.

Also, the clothing detecting unit 46 detects clothing of a user who is operating the mobile terminal 10 and determines the type of the clothing. In addition, when another user is included in an image, the clothing detecting unit 46 may determine the types of clothing of the non-user person. For example, when a plurality of people are included in an image, the clothing detecting unit 46 may determine whether the group of people wears formal clothing or casual clothing. Also, the clothing detecting unit 46 may classify types of clothing based on color signals detected by the image capturing element of the built-in camera 16. When clothing is mostly colored with subdued colors such as black, dark blue, gray and beige, the clothing detecting unit 46 determines it is formal clothing, and when clothing is colored with vivid colors such as red, blue, and yellow, the clothing detecting unit 46 determines it is casual clothing.

The communicating unit 36 communicates with servers on a network and other mobile terminals. In one example, the communicating unit 36 has a wireless communicating unit that accesses a wide area network such as the Internet, a Bluetooth (registered trademark) unit that realizes Bluetooth (registered trademark) communication, a Felica (registered trademark) chip and the like, and communicates with servers and other mobile terminals.

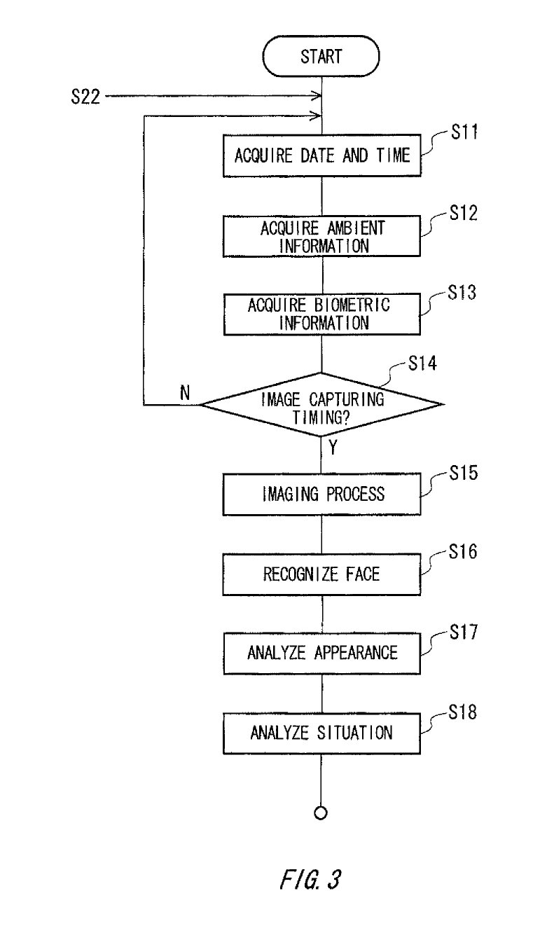

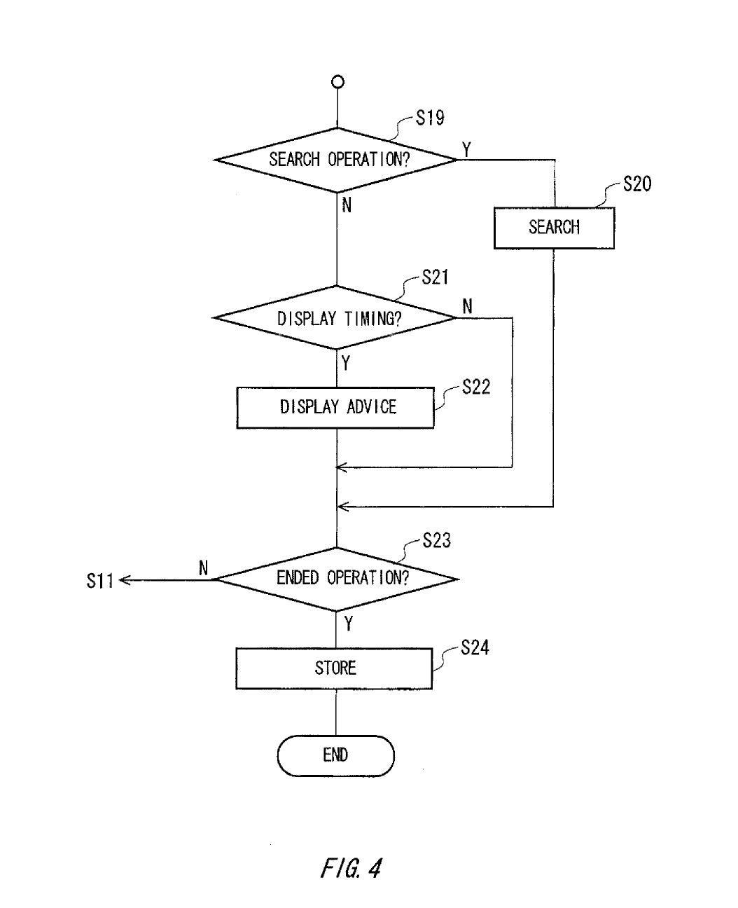

FIG. 3 shows a control flow of the mobile terminal 10 according to the present embodiment. FIG. 4 shows a control flow that follows the control flow of FIG. 3.

When operation by a user starts, the mobile terminal 10 executes processing shown in FIGS. 3 and 4. In one example, the mobile terminal 10 determines that operation by a user has started under a condition that the biosensor 20 has detected that the user is holding the mobile terminal 10, and the user has touched the touch panel 14.

First, the CPU 22 acquires, from the calendar part 28, the date and time when the operation is started (Step S11). In the present example, it is assumed that the CPU 22 acquires information that it is 11:30 a.m., on a weekday in October.

Next, the CPU 22 acquire ambient environment information from various sensors (Step S12). In one example, the CPU 22 acquires positional information from the GPS module 24, and acquires temperature information from the thermometer 26. Also, in one example, the CPU 22 acquires humidity information from an unillustrated hygrometer, in addition to the temperature information. In the present example, it is assumed that the CPU 22 acquires positional information from the GPS module 24, and acquires temperature information indicating 20° C. from the thermometer 26.

Next, the CPU 22 acquires biometric information of the user (Step S13). In one example, the CPU 22 acquires, from the biosensor 20, information about the body temperature, pulse, blood pressure, and the like of the user. In the present example, the CPU 22 acquires, from the biosensor 20, information indicating a pulse and a blood pressure that are higher than normal values, and acquires information indicating perspiration from a hand. The processing order of Steps S11, S12, and S13 may be changed as appropriate.

Next, the CPU 22 determines whether it is an image capturing timing based on the acquired date and time, ambient environment information, and biometric information (Step S14). In one example, when the date and time, ambient environment information, and biometric information meet predetermined conditions, the CPU 22 determines that it is the image capturing timing. For example, when it is in a time zone for the user to be in the business area, and biometric information indicating that the user is nervous, the CPU 22 may determine that it is the image capturing timing. Also, the CPU 22 may determine that it is the image capturing timing when, judging based on outputs of the GPS module 24, the user is at a location where he/she visits for the first time or at a location where the last visit was long time ago (location where a certain length of time has passed since he/she visited there last time).

If it is the image capturing timing (Yes at Step 14), the CPU 22 proceeds with the processing at Step S15. Also, if it is not the image capturing timing (No at Step 14), the CPU 22 returns to the processing at Step S11, and repeats the processing at and after Step 11 for example after a certain length of time. Also, if it is not the image capturing timing (No at Step 14), the CPU 22 may exit the flow and end the processing.

Next, if it is determined as the image capturing timing, the CPU 22 captures an image of the user and a space around the user with the built-in camera 16 (Step S15). Along with this, the CPU 22 acquires sound of the ambient environment of the user with the microphone 18.

Next, the image analyzing unit 34 analyzes the image captured by the built-in camera 16, and recognizes a face included in the captured image (Step S16). In one example, the image analyzing unit 34 compares image data of a face included in the captured image with facial data stored in the nonvolatile memory 30 to recognize the user who is operating the mobile terminal 10. Furthermore, when a face of a person other than the user is included in the captured image, the image analyzing unit 34 additionally recognizes the face of the non-user person. In the present example, it is assumed that the image analyzing unit 34 recognizes a face of a male user. Furthermore, in the present example, it is assumed that the image analyzing unit 34 detects that there is a face next to the user, but does not recognize the face of the person next to the user.

Next, the image analyzing unit 34 analyzes the appearance of the user (Step S17). In one example, the image analyzing unit 34 detects clothing of the user to classify the type of the user's clothing. In one example, the image analyzing unit 34 determines whether the user's clothing is formal or casual. In this case, as one example, the image analyzing unit 34 performs pattern matching of a region of the captured image below a portion recognized as a face, and preregistered clothing data to classify the type of the user's clothing. In one example, the image analyzing unit 34 detects the color tone of the region of the captured image below the portion recognized as a face, and classifies the type of the user's clothing. Also, the image analyzing unit 34 may classify the type of the user's clothing by performing pattern matching of characteristic shapes of clothing stored in the nonvolatile memory 30, or the above-described classification methods may be combined.

Next, the CPU 22 analyzes the situation of the user (Step S18). The CPU 22 determines the situation of the user according to the appearance of the user. In one example, the CPU 22 determines that it is a business situation if the user's clothing is formal, and it is a private situation if the user's clothing is casual.

Furthermore, in one example, the CPU 22 determines the situation of the user based on the date and time. In one example, the CPU 22 determines that it is a business situation if it is in between 9 a.m. to 6 p.m. on a weekday, and it is a private situation if it is in the other time zone.

Additionally, in one example, the CPU 22 analyzes the situation according to the position of the user. In one example, the CPU 22 determines that it is a business satiation when the user is near his/her company, and it is a private situation when the user is near his/her home.

Additionally, in one example, the CPU 22 analyzes the situation of the user based on biometric information. In one example, the CPU 22 determines that it is a situation where the user is nervous when the blood pressure, pulse, or perspiration of a hand are higher than those at normal situations.

Additionally, in one example, the CPU 22 analyzes the situation of the user based on a recognized facial expression of the user. In one example, the CPU 22 determines that it is a situation where the user is nervous when the user shows a nervous facial expression, and it is a relaxed situation when the user shows a relaxed facial expression.

Additionally, in one example, the CPU 22 analyzes the situation of the user based on language of the user or a person around the user that is analyzed based on sound acquired with the microphone 18. In one example, the CPU 22 determines that it is a business situation when ends of sentences of the user belong to the first category, it is a situation where the user sees a friend if language of the user belongs to the second category, and it is a situation where the user sees a more intimate friend when language of the user belongs to the third category. In the present example, it is assumed that the CPU 22 detects that the user says “What would you like to eat, sir?”, and because the end of the phrase includes “sir”, determines that the language belongs to the first category.

Also, the CPU 22 may determine the situation of the user in more detail by considering the above-described determination results together. In the present example, it is assumed that the CPU 22 acquires an analysis result indicating that the user is in a business area, wearing formal clothing, in the morning of a weekday (business time), is nervous, and is speaking polite language to a less acquainted person (person who is not so intimate).

When determination of the situation of the user ends, the CPU 22 next determines whether operation of the user is a search operation for searching and acquiring information from a network using the communicating unit 36 (Step S19). When the user's operation is a search operation (Yes at Step 19), the CPU 22 proceeds with the processing at Step S20, and when the user's operation is not a search operation (No at Step 19), the CPU 22 proceeds with the processing at Step S21.

When the user's operation is a search operation (Yes at Step S19), the CPU 22 adds a keyword corresponding to the user's situation to a search keyword input by the user for a search, and executes the search (Step S20). Thereby, the CPU 22 can provide information, acquired from the network, suited for the user's situation.

In the present example, the CPU 22 adds the keyword “formal” representing the user's situation that is determined from the clothing, to the search keyword “lunch” input by the user, and executes the search. Thereby, the CPU 22 can acquire information, from the network, such as restaurants for lunch suited from the formal situation.

Also, the CPU 22 may add a keyword according to the situation determined based on differences of language of the user, in place of the situation determined based on the user's clothing. In one example, the CPU 22 adds a keyword such as “fast food” or “family occasion” and executes the search when the user's appearance is formal, but the ends of the user's language belong to the second category or the third category.

Also, when the sound analyzing unit 32 identifies the term “meal” in words of the user, the CPU 22 may display a message according to the identified term, such as “Want to search with the word ‘lunch’?” on the display 12 upon receiving operation of the user on a search menu through the touch panel 14. Also, the CPU 22 may enhance the sensitivity of the touch panel 14 by processing with software or enlarge fonts of texts displayed on the display 12 if it is determined the user is in a rush based on biometric information detected by the biosensor 20 (such as when the sympathetic nerve becomes more active, and the blood pressure and heart rate rise, or the user sweats).

On the other hand, when the user's operation is not a search operation (No at Step 19), the CPU 22 determines whether it is a timing to display an advice to the user (Step S21). In one example, when the user is operating the touch panel 14, and the amount of inputs (operation amount) is more than a preset amount, the CPU 22 determines that it is not a timing to display an advice. Also, in one example, when the user's emotion or feeling shows little change, judging based on detection results of the biosensor 20, the CPU 22 determines that it is a timing to display an advice. Also, on the contrary, in one example, when the user's emotion or feeling shows a significant change, the CPU 22 determines that it is a timing to display an advice.

If it is determined that it is a timing to display an advice (Yes at Step 21), the CPU 22 proceeds with the processing at Step S22. Also, if it is determined that it is not a timing to display an advice (No at Step 21), the CPU 22 skips Step S22, and proceeds with the processing at Step 23. If it is determined that it is not a timing to display an advice at Step S21, the CPU 22 may repeat the processing at Step S21 for a certain length of time until it is determined that it is a timing to display an advice.

Next, the CPU 22 displays, on the display 12, an advice with contents according to the situation of the user determined at Step S18 (Step S22). In one example, the CPU 22 displays information about topics that can be used as reference for a conversion, according to the user's situation. Thereby, the CPU 22 can provide the user with appropriate information about topics for example when the user is nervous having lunch with a less acquainted person. More specifically, when the user is in a business situation, having lunch wearing formal clothing, the CPU 22 instructs display of news about politics, economy, incidents, and the like. Furthermore, the CPU 22 may provide information based on keywords identified in the conversation of the user. In this case, for example when the keyword “currency exchange” is identified in the conversation of the user, the CPU 22 displays the latest currency exchange rate and the like.

Also, there may be cases that the user who wears casual clothing happens to be with a less acquainted person and cannot have a good conversation. In such a case, in one example, the CPU 22 may display information about topics of the season, judging based on the date and time acquired from the calendar part 28, or information about topics of the neighborhood of the location, judging based on the positional information from the GPS module 24.

Additionally, the CPU 22 may display information about topics according to clothing detected by the clothing detecting unit 46. For example, when the user wears a white tie, and it is determined, based on the positional information detected by the GPS module 24 and map information, that the user is near a wedding hall, the CPU 22 acquires information about marriage from an external server using the communicating unit 36 to display the information, or display information about complimentary speeches, speech examples, manners, and the like stored in the nonvolatile memory 30. Also, for example, when the user wears a black tie, and it is determined that, based on the positional information detected by the GPS module 24 and map information, that the user is near a funeral hall, the CPU 22 displays information about condolences and maters to be cared about (information about words to be avoided, manners, and the like) stored in the nonvolatile memory 30.

When there is a predetermined action on the mobile terminal 10 (e.g., when the mobile terminal 10 is gripped with a predetermined force or larger), the CPU 22 may determine that it is a timing to display information, and display the information. Also, the CPU 22 may notify the user, upon acquisition of a search result, that information has been retrieved with an unillustrated vibration function.

Next, the CPU 22 determines whether the user is continuing operation of the mobile terminal 10 (Step S23). In one example, when the built-in camera 16 is continuing capturing images of the user, the CPU 22 may determine that the user is continuing operation. When the user is continuing operation of the mobile terminal 10, the CPU 22 returns to Step S11 and repeats the processing. When the user has ended operation, the CPU 22 records, in the nonvolatile memory 30, the operation time of the user on the mobile terminal 10, the user's situation analyzed at Step S18, search results, advice information, and the like (Step S24), exits the flow, and ends the processing.

At Step S24, the CPU 22 may record, in the nonvolatile memory 30, facial data of a person, recognized in image data, who has not been registered in the nonvolatile memory 30. Thereby, the CPU 22 can utilize the facial data of the person for facial recognition when the user sees the person next time.

Also, at Step S24, the CPU 22 may record the category of the language of the user in association with conversation partners. Then, when the category of the language that the user used to speak in a conversation with the same person in the past is different from the category of the language that the user speaks currently, the CPU 22 may notify the user of the fact. For example, when the language of the user in conversations with the same person changes from the first category to the second category, the CPU 22 notifies the user of the fact. Thereby, the CPU 22 can notify the user that the user has opened up more to the person after several meetings. Also, the CPU 22 may record the language of the conversation partner. In this case, the CPU 22 may notify that the language of the user and the partner is not balanced when the category of the language of the user is different from the category of the language of the partner.

Also, the CPU 22 may execute the processing of the flowcharts shown in FIGS. 3 and 4 when the user is alone. For example, the CPU 22 may display information according to the user's clothing when the user is alone. More specifically, in one example, the CPU 22 displays that “the clothing is light clothing” on the display 12, if the user wears short sleeves even when the user is at home and the room temperature is below 15° C. Also, in one example, the CPU 22 displays “time to drink liquids” on the display 12 when the temperature is above 30° C.

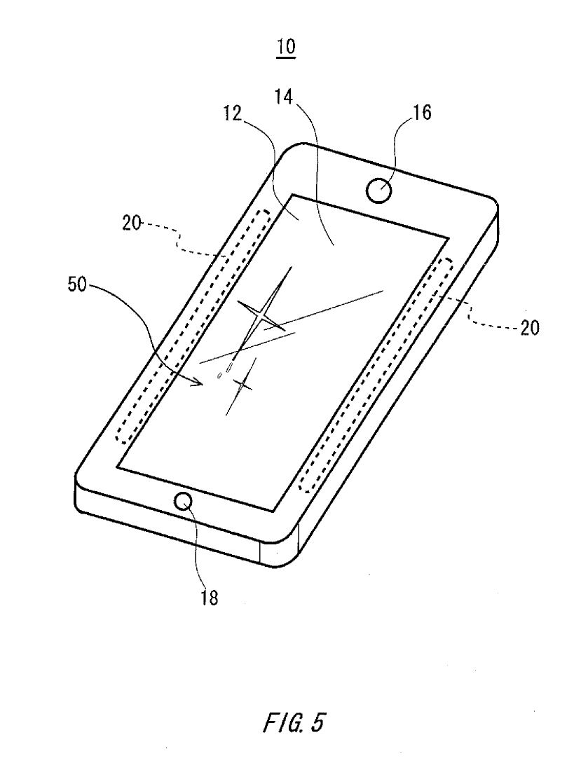

FIG. 5 shows the configuration of the external appearance of the mobile terminal 10 according to a variant of the present embodiment. The mobile terminal 10 according to the present variant has the substantially same configuration and functions with the mobile terminal 10 explained in conjuncture with FIGS. 1 to 4; therefore, the same reference numerals are provided to identical components, and only differences are explained.

The mobile terminal 10 according to the present variant further includes a mirror film 50 in addition to the configuration shown in FIG. 1. The mirror film 50 is pasted, for example by adhesion, on the surface of the display 12. The mirror film 50 is a transmissive film having reflectivity, which transmits light irradiated from the rear (the display 12) side to the front side, but functions as a reflective film when light is not irradiated from the rear (the display 12) side.

Accordingly, the mobile terminal 10 provided with the mirror film 50 functions as a small mirror that can be used for makeup in a state that light is not emitted from the display 12 (e.g., when the mobile terminal 10 is turned off). The mobile terminal 10 may be provided with a mirror, instead of the mirror film 50, at a portion on the same surface with the display 12, but not on the display 12.

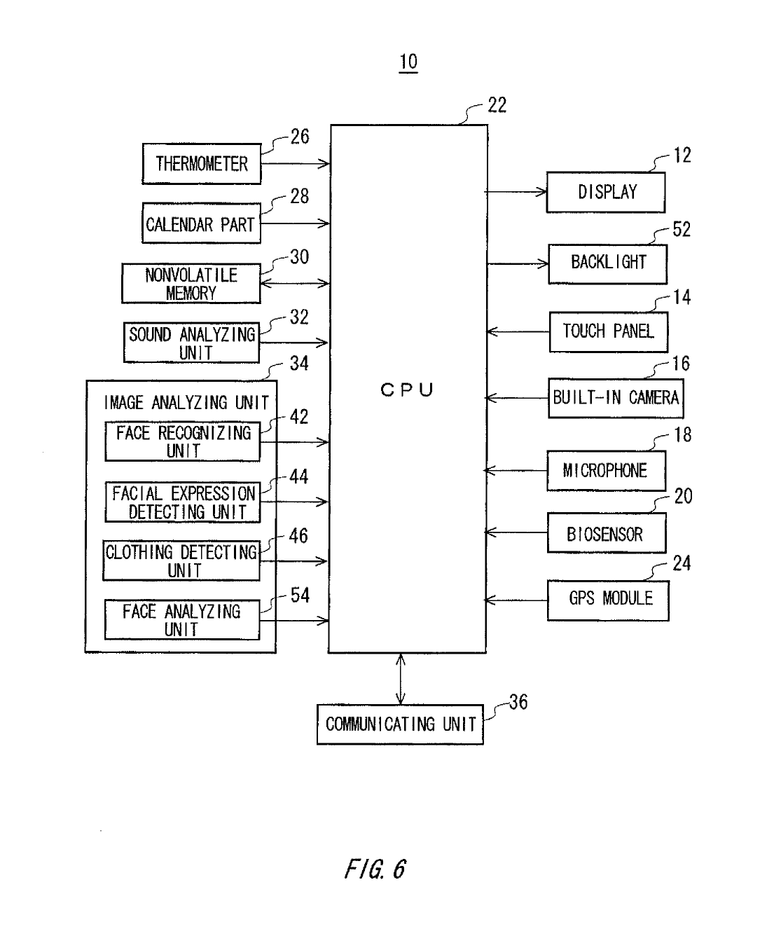

FIG. 6 shows the functions and configuration of the mobile terminal 10 according to the variant. The mobile terminal 10 according to the present variant further includes a backlight 52 in addition to the configuration shown in FIG. 2. Also, in the present variant, the image analyzing unit 34 further has a face analyzing unit 54 in addition to the configuration shown in FIG. 2.

The backlight 52 has a light source, and irradiates light from the rear side of the screen to the display 12, which is a liquid crystal display unit and the like. The CPU 22 controls turning on and off, and the light amount of the light source of the backlight 52. More specifically, when the user is operating the touch panel 14, and information is to be displayed on the display 12, the CPU 22 turns on the backlight 52, and enhances the visibility of the display 12. Also, when the user is not operating the touch panel 14, the CPU 22 turns off the backlight 52. Also, when operation to turn off the backlight 52 is performed, the CPU 22 turns off the backlight 52.

The face analyzing unit 54 analyzes a change in the face of the user based on changes in image capturing results of the built-in camera 16 and color signals from the image capturing element of the built-in camera 16. In one example, the face analyzing unit 54 analyzes whether the user's makeup has come off. More specifically, the face analyzing unit 54 analyzes whether there is a glaze portion on the face or a loss of color of lip rouge. A method of detecting a glaze portion on a face is disclosed for example in Japanese Patent No. 4396387.

Also, the face analyzing unit 54 determines whether there is a color change at a lip part in comparison with a color facial image of the user captured before leaving home (e.g., before commute), and detects a loss of color of lip rouge. Also, the face analyzing unit 54 may store, in the nonvolatile memory 30, daily data of facial images of the user and states of lip rouge, compares the data in the nonvolatile memory 30 with a captured facial image of the user, and detect a loss of color of lip rouge.

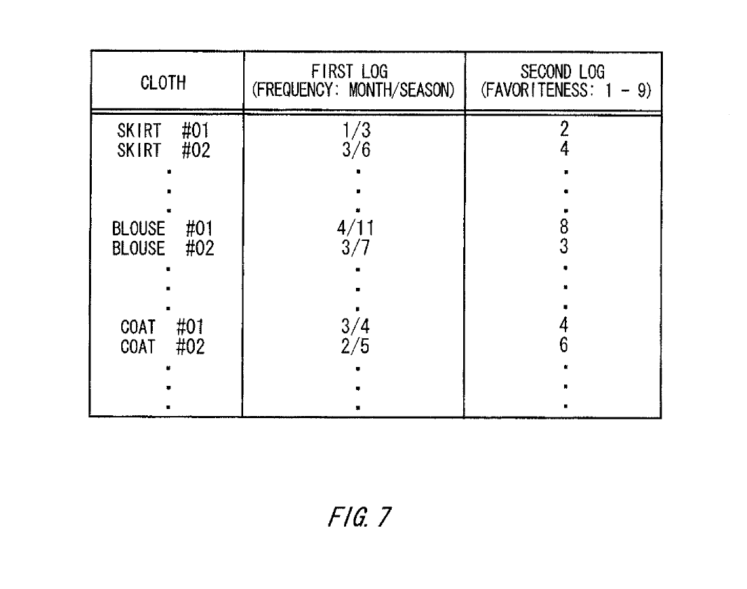

FIG. 7 shows an exemplary table in which image data and a log of clothing owned by a user are described. In the present variant, the nonvolatile memory 30 stores therein image data of a plurality of pieces of clothing owned by the user. For example, the nonvolatile memory 30 stores therein image data of skirts, blouses, coats, and the like owned by the user.

The CPU 22 adds image data of new pieces of clothing into the nonvolatile memory 30 as appropriate. In one example, when the user purchases clothing at an online shop through a network and the like, the CPU 22 registers images of the clothing, names, and the like in the nonvolatile memory 30. Also, when the user captures images of new pieces of clothing, the CPU 22 registers the images of clothing, names and the like in the nonvolatile memory 30. Also, the clothing is not limited to clothes, but may include accessories, hats, shoes, bags, and the like.

Also, the nonvolatile memory 30 registers therein a first log and a second log in association with each piece of the clothing. The first log includes the frequencies indicating how often the clothing is worn. In one example, the first log includes the frequencies per month and the frequencies per season. Also, the second log includes levels of favoriteness of the clothing of the user. In one example, the second log includes levels of favoriteness indicated with values from 1 to 9. The first log and the second log are updated in a manner explained in the following flow.

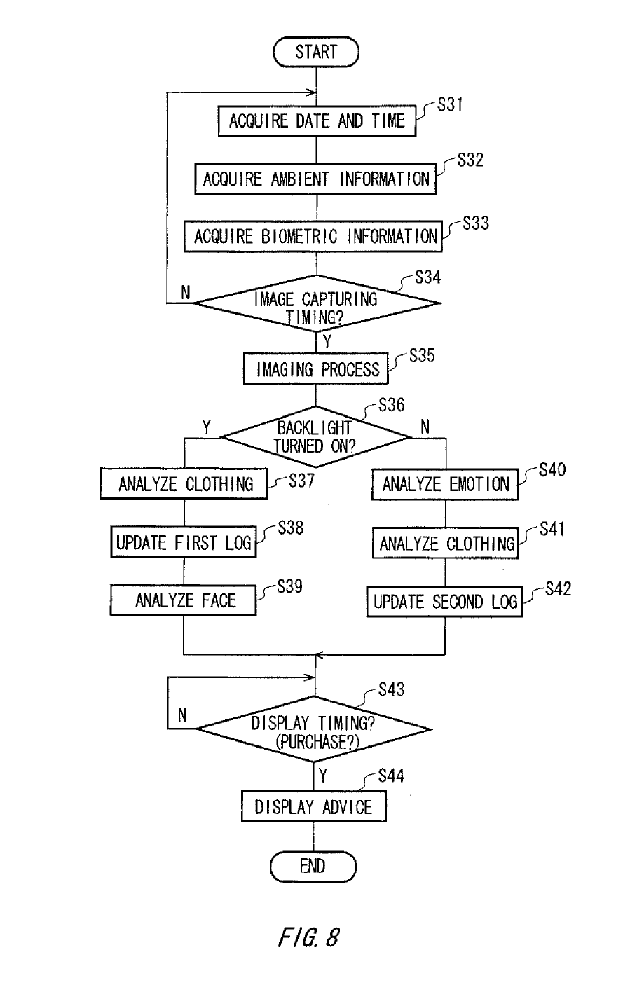

FIG. 8 shows a control flow of the mobile terminal 10 according to the present embodiment. The mobile terminal 10 executes the processing shown in FIG. 8 when it is detected that the user is operating the mobile terminal 10 or that the user is holding the mobile terminal.

The CPU 22 acquires, from the calendar part 28, the date and time when operation is started (Step S31). Next, the CPU 22 acquires ambient environment information from various sensors (Step S32). Next, the CPU 22 acquires biometric information of the user (Step S33). The processing at Steps S31, S32, and S33 is similar to the processing at Steps S11, S12, and S13 of the flowcharts shown in FIGS. 3 and 4.

Next, the CPU 22 determines whether it is an image capturing timing based on the acquired date and time, ambient environment information, and biometric information (Step S34). In one example, when the date and time, ambient environment information, and biometric information meet preset conditions, the CPU 22 determines that it is the image capturing timing.

For example, when the user is at home in a time zone before leaving home (e.g., before commute), or when the user is at his/her company in a time zone a certain length of time after commute to the company, the CPU 22 may determine that it is the image capturing timing. If it is the image capturing timing (Yes at Step 34), the CPU 22 proceeds with the processing at Step S35. Also, if it is not the image capturing timing (No at Step 34), the CPU 22 returns to Step S31, and repeats the processing at and after Step S31 for example after a certain length of time. Also, if it is not the image capturing timing (No at Step 34), the CPU 22 may exit the flow, and end the processing.

Next, if it is determined that it is the image capturing timing, the CPU 22 captures an image of the user with the built-in camera 16 (Step S35). In this case, the CPU 22 captures an image at an angle that enables recognition of the user's face, and the user's clothing.

Next, the CPU 22 determines whether the backlight 52 is turned on or off (Step S36). The backlight 52 being turned on means that the user is operating the mobile terminal 10 or viewing information displayed on the mobile terminal 10. On the contrary, when the backlight 52 is turned off, it is likely that the user is using the mobile terminal 10 as a mirror.

When the backlight 52 is turned off, that is, when the user is operating the mobile terminal 10 or viewing displayed information (Yes at Step 36), the CPU 22 proceeds with the processing at Step S37. Also, when the backlight 52 is turned off, that is, when the user is using the mobile terminal 10 as a mirror (No at Step 36), the CPU 22 proceeds with the processing at Step S40.

In the processing performed when the backlight 52 is turned on, the image analyzing unit 34 performs pattern matching and the like of image data of a clothing part in a captured image of the user and image data of the user's clothing stored in the nonvolatile memory 30, and identifies which pieces of clothing, among the clothing owned by the user, the pieces of clothing worn by the user are (Step S37). Furthermore, the image analyzing unit 34 may further distinguish a combination of the identified clothing.

Next, the CPU 22 updates the first log corresponding to the identified clothing (Step S38). More specifically, the CPU 22 adds one to the frequencies corresponding to the identified clothing (the frequencies of the current month, and the frequencies of the current season). Furthermore, when a combination of the clothing is identified, the CPU 22 stores, in the nonvolatile memory 30, information about the identified combination.

Also, the CPU 22 may perform the processing at Steps S37 and S38 only once a day. Thereby, the CPU 22 can daily update frequency information indicating how often the user wears each piece of the clothing owned by user. When the user's clothing cannot be detected because the captured image is unclear, the CPU 22 skips the processing at Steps S37 and S38.

Next, the image analyzing unit 34 analyzes the face of the user (Step S39). More specifically, the image analyzing unit 34 analyzes whether makeup has come off due to a loss of color of lip rouge or a glaze portion of the face, based on the facial image of the user. Also, when the user is male, the image analyzing unit 34 may analyze whether a beard and a mustache have grown long. In one example, the image analyzing unit 34 compares a facial image of the user captured before leaving home (e.g., before commute) with the facial image captured at Step S35, and analyzes whether makeup has come off or whether a beard and a mustached have grown long. After ending the processing at Step S39, the CPU 22 proceeds with the processing at Step S43.

On the other hand, when the backlight 52 is turned off, the CPU 22 analyzes the emotion of the user (Step S40). In one example, the CPU 22 analyzes whether the user is feeling good, feeling normal, or feeling bad based on detection results of the biosensor 20, a facial expression analyzed according to the facial image, and the like.

Next, the image analyzing unit 34 performs pattern matching and the like of image data of a clothing part in a captured image of the user, and image data of the user's clothing stored in the nonvolatile memory 30, and identifies which pieces of clothing, among the clothing owned by the user, the pieces of clothing worn by the user are (Step S41).

Next, the CPU 22 updates the second log corresponding to the identified clothing according to the emotion of the user analyzed at Step S40. More specifically, if the user is feeling good, the CPU 22 raises the level of favoriteness of the identified clothing. Also, if the user is feeling normal, the CPU 22 does not change the level of favoriteness of the identified clothing. Also, if the user is feeling bad, the CPU 22 lowers the level of favoriteness of the identified clothing.

When the backlight 52 is turned off and the user is holding the mobile terminal 10, it is likely that the user is using the mobile terminal 10 as a mirror. In such a case, it is likely that the user gets to feel good when the user is fond of the clothing the user is wearing, and that the user gets to feel bad when the user is not fond of the clothing the user is wearing. Therefore, by keeping a record of the emotion of the user in each state in association with the clothing the user is wearing for a long period, such a record can be used as an index indicating whether the user is or is not fond of the clothing.

The CPU 22 may execute the processing at Steps S40 to 42 under a condition that the user has not left home (before commute). Also, the CPU 22 may perform the processing at Steps S40 to 43 only once a day. Also, when the user's clothing cannot be detected because the captured image is unclear, the CPU 22 skips the processing at Steps S40 to 42. After ending the processing at Step S42, the CPU 22 proceeds with the processing at S43.

Next, at Step S43, the CPU 22 determines whether it is a timing to display an advice to the user. If it is a timing to display an advice to the user (Yes at Step 43), the CPU 22 displays the advice to the user at Step S44. If it is not a timing to display an advice to the user (No at Step 43), the CPU 22 waits to perform the processing until it is a timing to display an advice at S43. If it is not a timing to display an advice to the user, the CPU 22 may exit the flow and ends the processing after waiting to perform the processing at Step S43 for a certain length of time.

At Step S44, in one example, the CPU 22 displays contents indicated in the second log at a timing when the user purchases clothing and the like at an online shop through a network. In one example, the CPU 22 displays image data of clothing with a high level of favoriteness or image data of clothing with a low level of favoriteness at a timing of purchasing clothing and the like. Thereby, the user can confirm his/her taste at the time of purchasing new pieces of clothing and the like.

Also, at the time of purchasing clothing and the like at an online shop through a network, if the user is about to purchase clothing that is similar in design to the clothing that he/she already owns, the CPU 22 may display an advice to remind the user of the fact. Thereby, the user can avoid purchasing similar and overlapping clothing.

Also, the CPU 22 displays to the user clothing and the like that the user wears often and clothing and the like the user does not wear often, by referring to the first log. Thereby, the user can know that only particular pieces of clothing is worn by the user, and can utilize the knowledge in selecting clothing to wear.

Also, when the user is at his/her company in a time zone a certain length of time after commute to the company, and it is detected at Step S39 that makeup has come off (a glaze portion on the face or a loss of color of lip rouge), or that a beard and a mustache have grown long, the CPU 22 may display the fact. Thereby, the user can know that it is a timing to fix the makeup or to shave.

Then, after completing the processing at Step S44, the CPU 22 exits the flow and ends the processing. The CPU 22 may return to the processing at Step S35, and repeats the processing of and after the image capturing process again when it is necessary to continue capturing images of the face of the user because the data amount is insufficient or acquired data is still showing changes after an advice is displayed.

While the embodiment(s) of the present invention has (have) been described, the technical scope of the invention is not limited to the above described embodiment(s). It is apparent to persons skilled in the art that various alterations and improvements can be added to the above-described embodiment(s). It is also apparent from the scope of the claims that the embodiments added with such alterations or improvements can be included in the technical scope of the invention.

The operations, procedures, steps, and stages of each process performed by an apparatus, system, program, and method shown in the claims, embodiments, or diagrams can be performed in any order as long as the order is not indicated by “prior to,” “before,” or the like and as long as the output from a previous process is not used in a later process. Even if the process flow is described using phrases such as “first” or “next” in the claims, embodiments, or diagrams, it does not necessarily mean that the process must be performed in this order.

### DESCRIPTION OF REFERENCE NUMERALS

10 mobile terminal
12 display
14 touch panel
16 built-in camera
18 microphone
20 biosensor
22 CPU
24 GPS module
26 thermometer
28 calendar part
30 nonvolatile memory
32 sound analyzing unit
34 image analyzing unit
36 communicating unit
42 face recognizing unit
44 facial expression detecting unit
46 clothing detecting unit
50 mirror film
52 backlight
54 face analyzing unit

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. A computer-readable medium including computer-readable instructions that, when executed by at least one processor, cause the at least one processor to perform operations comprising;
storing an image data of an own appearance with a classification information of the own appearance on a memory; and
displaying the own appearance on a display when a communicating unit is connected to an online shop;
wherein the display and the communicating unit are included in a mobile terminal that further includes the memory.

41. The computer-readable medium according to claim 40, wherein the classification information is one of formal and casual.

42. The computer-readable medium according to claim 40, wherein the classification information is a color tone.

43. The computer-readable medium according to claim 40, wherein the classification information is determined from the image data.

44. The computer-readable medium according to claim 40, wherein the classification information is determined by a shape of the own appearance.

45. The computer-readable medium according to claim 40, wherein the classification information is determined by a season.

46. The computer-readable medium according to claim 40, wherein the classification information is determined by a frequency of use.

47. The computer-readable medium according to claim 40, wherein the own appearance is a piece of clothing.

48. The computer-readable medium according to claim 40, further comprising an instruction that, when executed by the at least one processor, causes the at least one processor to capture the image data with a camera included in the mobile terminal.

49. The computer-readable medium according to claim 48, wherein the camera and the display are located on a single surface of the mobile terminal.

50. The computer-readable medium according to claim 48, further comprising an instruction that, when executed by the at least one processor, causes the at least one processor to register the own appearance in response to the capturing.

51. The computer-readable medium according to claim 50, wherein the registering includes registering the own appearance with a face.

52. The computer-readable medium according to claim 51, wherein the registering includes analyzing the face.

53. The computer-readable medium according to claim 52, wherein the analyzing includes determining an expression of the face.

54. The computer-readable medium according to claim 40, further comprising an instruction that, when executed by the at least one processor, causes the at least one processor to issue an alert when an owned piece of clothing is similar in design to a new piece of clothing of the online shop.

55. A mobile terminal comprising:
a processor;
a display in communication with the processor;
a communicating unit in communication with the processor;
a memory including computer-readable instructions that, when executed by a processor, cause the processor to:
store an image data of an own appearance with a classification information of the own appearance on the memory; and
display the own appearance on a display when a communicating unit is connected to an online shop.

56. The mobile terminal according to claim 55, wherein the classification information is one of formal and casual.

57. The mobile terminal according to claim 55, wherein the classification information is a color tone.

58. The mobile terminal according to claim 55, wherein the classification information is determined from the image data.

59. The mobile terminal according to claim 55, wherein the classification information is determined by a shape of the own appearance.

60. The mobile terminal according to claim 55, wherein the classification information is determined by a season.

61. The mobile terminal according to claim 55, wherein the classification information is determined by a frequency of use.

62. The mobile terminal according to claim 55, further comprising a camera operable to capture the image data of the own appearance.

63. The mobile terminal according to claim 62, wherein the camera and the display are located on a single surface of the mobile terminal.
